(19) United States
(12) Patent Application Publication
(10) Pub. No.: US 2025/0034348 A1
(43) Pub. Date: Jan. 30, 2025

(54) PYROLYSIS METHOD OF WASTE PLASTICS USING WASTE RESOURCES

(71) Applicants: SK INNOVATION CO., LTD., Seoul (KR); SK GEO CENTRIC CO., LTD., Seoul (KR)

(72) Inventors: Sanghwan JO, Daejeon (KR); Sookil KANG, Daejeon (KR); Howon LEE, Daejeon (KR); Jaeheum JUNG, Daejeon (KR)

(21) Appl. No.: 18/703,257

(22) PCT Filed: Oct. 19, 2022
(86) PCT No.: PCT/KR2022/015964

§ 371 Date: Apr. 19, 2024

(30) Foreign Application Priority Data
Oct. 20, 2021 (KR) 10-2021-0140289

(51) Int. Cl. C08J 11/12; C08J 11/16; C10G 1/10

(52) U.S. Cl. CPC C08J 11/12; C08J 11/16; C10G 1/10; C10G 2300/1003

(57) ABSTRACT

Provided is a method of producing a waste plastic pyrolysis oil including a pyrolysis process of putting waste plastics and a slag composition into a pyrolysis reactor to produce a pyrolysis oil, wherein the slag composition includes 30 to 60 wt % of a calcium oxide; 5 to 30 wt % of an iron oxide; and 0.5 to 30 wt % of at least one selected from a silicon oxide, an aluminum oxide, and a magnesium oxide.

This application is a national stage application of PCT/KR2022/015964 filed on Oct. 19, 2022, which claims priority of Korean patent application number 10-2021-0140289 filed on Oct. 20, 2021. The disclosure of each of the foregoing applications is incorporated herein by reference in its entirety.

### TECHNICAL FIELD

Embodiments of the present disclosure generally relate to a pyrolysis method of waste plastics using waste resources.

### BACKGROUND ART

Since a large amount of impurities resulting from a waste material are included in oil (waste oil) produced by a cracking or a pyrolysis reaction of the waste material such as a waste plastic pyrolysis oil, when the oil is used as a fuel, air pollutants such as SOₓ and NOₓ may be released. In particular, a Cl component may be converted into HCl and also may be released into the atmosphere. The HCL causes device corrosion in a high-temperature treatment process.

Typically, according to conventional existing methods, Cl is removed by converting Cl into HCl by a hydrotreating (HDT) process using a refinery technique, but since waste oil such as waste plastic pyrolysis oil has high Cl content, issues with equipment corrosion, reaction abnormality, and deterioration of product properties formed in the HDT process have been reported, and it is difficult to practically introduce untreated waste oil to the HDT process.

A technology using an adsorbent to reduce the Cl, and N has been developed for pretreating waste oil before introducing it to an HDT process. However, this technology of reducing Cl, and N, (and the like) using an adsorbent such as CaO or spent FCC catalyst (E-cat) requires raw material oil having a rather very low impurity content, and very large amounts of the adsorbent e.g., from about 2 to 50 times the amount of the oil to be refined. In addition, the adsorbent material loses adsorption ability and requires continuous replacement.

Thus, a new waste oil treatment technology for reducing the impurity content of waste oil to an adequately low level so that the waste oil may be introduced to a refinery process is needed.

### SUMMARY

An object of the embodiments of the present disclosure is to provide a technology of reducing impurities (e.g., Cl) in pyrolysis using a steel slag which is a waste resource, by replacing Cao or E-cat commonly used in a waste plastic pyrolysis technical field.

Among steel slags, about 70% of a blast furnace slag is recycled as a cement raw material with high added value, but all of a steel-making slag is simply buried, for example, as aggregates for embankment or roads. Since a steel-making slag has a very different chemical composition from that of a blast furnace slag, it is impossible to apply the steel-making slag as cement, and the use as a concrete aggregate thereof is limited due to a high content of free lime (free CaO) included in the steel-making slag. Thus, an object of the embodiments of the present disclosure is to remove impurities in pyrolysis of waste plastics by using unreacted free lime and a metal compound in the steel-making slag.

According to a first embodiment of the present disclosure, a method of producing a waste plastic pyrolysis oil includes a pyrolysis process of putting waste plastics and a slag composition into a pyrolysis reactor to produce a pyrolysis oil, wherein the slag composition includes 30 to 60 wt % of a calcium oxide; 5 to 30 wt % of an iron oxide; and 0.5 to 30 wt % of at least one selected from a silicon oxide, an aluminum oxide, and a magnesium oxide.

In an embodiment, the slag composition may satisfy the following Equations 1 and 2:

$$1 < iron oxide ( wt \% ) / silicon oxide ( wt \% ) < 3 \qquad Equation 1$$

$$3 < iron oxide ( wt \% ) / magnesium oxide ( wt \% ) < 5 \qquad Equation 2$$

In an embodiment, the slag composition may include 5 wt % or less of the aluminum oxide.

In an embodiment, the slag composition may include 20 wt % or less of the silicon oxide.

The pyrolysis process may be performed at a temperature of 400 to 600° C. under a non-oxidizing atmosphere.

The waste plastics may be household waste plastics including 3 wt % or more of polyvinyl chloride (PVC) with respect to the total weight.

The slag composition may have a BET specific surface area of 0.5 to 10 m²/g.

The slag composition may have a particle size of 5 to 200 μm.

The slag composition may have a compressive strength of 100 to 500 MPa.

The slag composition may have a density of 1.5 to 5 g/cm².

The pyrolysis oil may include less than 100 ppm of chlorine with respect to the total weight.

In the embodiments of the present disclosure, a pyrolysis oil having a low level of impurity content to be applied to a refinery process may be produced without performing a separate post-treatment process after pyrolysis of a waste plastic raw material.

In addition, unreacted free lime (free CaO) and a metal compound in a steel slag may be used to remove impurities in a waste plastic pyrolysis process.

### DETAILED DESCRIPTION

Unless otherwise defined herein, all terms used in the specification (including technical and scientific terms) may have the same meaning that is commonly understood by those skilled in the art. Throughout the present specification, unless explicitly described to the contrary, “comprising” any elements will be understood to imply further inclusion of other elements rather than the exclusion of any other elements. In addition, unless explicitly described to the contrary, a singular form includes a plural form herein.

In the present specification, “A to B” refers to “A or more and B or less”, unless otherwise particularly defined.

In addition, “A and/or B” refers to at least one selected from the group consisting of A and B, unless otherwise particularly defined.

An embodiment of the present disclosure provides a method of producing a waste plastic pyrolysis oil. The method includes a pyrolysis process of putting waste plastics and a slag composition into a pyrolysis reactor to produce a pyrolysis oil. In an embodiment of the present disclosure, chlorine may be removed from a pyrolysis oil at a very high level without performing a separate post-treatment process after pyrolyzing a waste plastic raw material.

In the pyrolysis process, waste plastics are put into a pyrolysis reactor, which is heated to produce a pyrolysis gas phase, a pyrolysis liquid phase including oil and wax, and a pyrolysis solid phase including a pyrolysis residue. The pyrolysis may be, for example, performed at a temperature of 400 to 600° C. under a non-oxidizing atmosphere.

The non-oxidizing atmosphere is an atmosphere in which waste plastics are not oxidized (not burn), and for example, may be an atmosphere having an oxygen concentration adjusted to 1 vol % or less, or an inert gas atmosphere of nitrogen, vapor, carbon dioxide, argon, and the like, or a negative pressure atmosphere.

When the pyrolysis temperature is 400° C. or higher, fusion of chlorine-containing plastics may be prevented, and when the pyrolysis temperature is 600° C. or lower, chlorine in waste plastics may remain in a form such as CaCl₂) in the slag composition, which is thus preferred.

The waste plastics may include at least one plastic material (or simply plastic) selected from the group consisting of polyethylene (PE), polypropylene (PP), polyethylene terephthalate (PET), polyvinyl chloride (PVC), and polystyrene (PS). The waste plastics may include organic chlorine (Cl) and inorganic chlorine (Cl). A large amount of impurities resulting from the waste plastics is included in the waste oil produced from the cracking and pyrolysis reactions of waste plastics such as a waste plastic pyrolysis oil. Thus, when the waste oil is used, there is a risk of emitting air pollutants, and in particular, organic chlorine and inorganic chlorine components may be emitted after being converted into HCl in a treatment process at a high temperature, and thus, it is necessary to pretreat the waste oil to remove the impurities from the chlorine component.

The waste plastics may be classified into household waste plastic wastes and industrial waste plastic wastes. The household waste plastic wastes are mixed plastics of PVC, PS, PET, PBT, and the like in addition to PE and PP, and in the present disclosure, may refer to mixed waste plastic wastes including 3 wt % or more of PVC with PE and PP. A chlorine content of the waste plastics may be, for example, 1,000 ppm or more, 3,000 ppm or more, or 5,000 to 15,000 ppm.

The slag composition includes 30 to 60 wt % of a calcium oxide; 5 to 30 wt % of an iron oxide; and 0.5 to 30 wt % of at least one selected from a silicon oxide, an aluminum oxide, and a magnesium oxide, with respect to the total weight.

The slag composition may be a steel slag which is a by-product produced in the manufacture of iron and steel in steel works, the steel slag may include a blast furnace slag and a steel-making slag. In an embodiment, the steel slag may be a steel-making slag. The blast furnace slag is widely used for an admixture for concrete, a blast furnace slag cement, and the like. The steel-making slag may include a converter slag which is a by-product of a steel converter process of producing a crude steel with a molten pig iron produced in a blast furnace, and an electric arc furnace slag which is a by-product in the manufacturing of a crude steel by melting scrap in an electric furnace. Since the steel-making slag has a very different chemical composition from that of the blast furnace slag, it is impossible to apply the steel-making slag as cement, and the use as a concrete aggregate thereof is limited due to a high content of free lime included in the steel-making slag. Unreacted free lime (free CaO) is a compound which is an environmental pollutant and limits the use of a slag, but in embodiments of the present disclosure, the unreacted free lime (free CaO) and a metal compound in the steel-making slag are used to remove impurities included in a raw material in the pyrolysis process of waste plastics.

The slag composition may include, specifically, 40 to 60 wt %, 35 to 55 wt %, or 40 to 50 wt % of the calcium oxide, 5 to 30 wt %, 10 to 25 wt %, or 15 to 20 wt % of the iron oxide, 5 to 20 wt %, 7 to 18 wt %, or 10 to 15 wt % of the silicon oxide, 0 to 10 wt %, and 0 to 5 wt %, or 0.5 to 3 wt % of the aluminum oxide and/or 0 to 15 wt %, 1 to 10 wt %, or 2 to 8 wt % of the magnesium oxide. The steel-making slag is a by-product of a steel-making process, and a change in the content of each component may vary within ±5% depending on the operating conditions. When the chemical composition range of the slag composition is satisfied, chlorine in the waste plastics and the metal oxides may react to form various metal chlorides (Fe₂Cl₃, CaCl₂, MgCl₂, SiCl₄, etc.), thereby resolving the issue that CaCl₂ and the like are dissociated into chlorine again even under pyrolysis reaction conditions at a high temperature. However, when Cao or spent FCC catalyst is used alone as in the conventional technology, one type of chlorine reaction product such as CaCl₂ is formed to facilitate a chlorine dissociation reaction, and a large amount of decomposed HCl may be trapped in a pyrolysis oil or produce organic Cl by a re-reaction.

In an embodiment, the slag composition may satisfy the following Equations 1 and 2:

$$1 < iron oxide ( wt \% ) / silicon oxide ( wt \% ) < 3 \qquad Equation 1$$

$$3 < iron oxide ( wt \% ) / magnesium oxide ( wt \% ) < 5 \qquad Equation 2$$

wherein the iron oxide (wt %), the silicon oxide (wt %), and the magnesium oxide (wt %) refer to wt % of the iron oxide, the silicon oxide, and the magnesium oxide with respect to the total weight of the slag composition, respectively.

When the slag composition satisfies the above Equations 1 and 2, the effect of reacting with chlorine to form a metal chloride is significantly improved, thereby minimizing chlorine in the produced waste plastic pyrolysis oil. Specifically, Equation 1 may be 1<iron oxide (wt %)/silicon oxide (wt %)<2.7, and Equation 2 may be 3.3<iron oxide (wt %)/magnesium oxide (wt %)<4.7. More specifically, Equation 1 may be 1.5<iron oxide (wt %)/silicon oxide (wt %) <2.5, and Equation 2 may be 3.5<iron oxide (wt %)/magnesium oxide (wt %)<4.5.

In an embodiment, the slag composition may include 5 wt % or less of the aluminum oxide. Specifically, the slag composition may include 4 wt % or less, more specifically 3 wt % or less of the aluminum oxide. When the range is satisfied, a chlorine removal effect may be further improved.

In an embodiment, the slag composition may include 20 wt % or less of the silicon oxide. Specifically, the slag composition may include 18 wt % or less, more specifically 15 wt % or less of the silicon oxide. When the range is satisfied, a chlorine removal effect may be further improved.

The slag composition may have a particle size of 5 to 200 μm, specifically 30 to 150 μm, or 60 to 80 μm.

The slag composition may have a BET specific surface area of 0.5 to 10 m²/g, specifically 1 to 8 m²/g, or 3 to 5 m²/g. When CaO particles are added to a pyrolysis reactor to pyrolyze waste plastics, calcium oxide (CaO) reacts with hydrogen chloride in the reactor to produce CaCl₂), and the produced ClCl₂ is melted to cause de-fluidization. Due to the slagging, process efficiency is greatly lowered, for example, process operation is stopped. Since the slag composition of the present disclosure includes an iron oxide, a silicon oxide, an aluminum oxide, and/or a magnesium oxide, as well as a calcium oxide, it has a less amount of CaCl₂ generated than Cao particles, and has a better chlorine removal effect than CaO or spent FCC E-cat having a higher BET specific surface area, and may suppress slagging and de-fluidization since by-products produced while removing chlorine are not melted and fused to the pores of the slag composition. It is analyzed that chemical properties have more influence on the removal of impurities such as chlorine from a pyrolysis oil than physical properties such as a BET specific surface area or a particle size. In particular, it is analyzed that the slag of the embodiments of the present disclosure has better Cl reduction ability as compared with the case of using spent FCC catalyst (spent FCC E-cat) having a high BET specific surface area, and the results mean that the slurry composition of the embodiments of the present disclosure have an excellent impurity removal effect by the chemical reaction, and thus, may overcome inferiority in physical properties.

The slag composition may have a compressive strength of 100 to 500 MPa, specifically 200 to 400 MPa, or 250 to 350 MPa. In addition, the slag composition may have a density of 1.5 to 5 g/cm², 2 to 4 g/cm², or 2.5 to 3.5 g/cm². The steel-making slag has a higher density value due to its higher iron content than the blast furnace slag. Thus, since the physical durability is improved, the steel-making slag may maintain the shape of slag composition particles under high temperature and high pressure conditions in the pyrolysis reactor even with its relatively high BET specific surface area. Therefore, since it is not accompanied by a pyrolysis gas or a pyrolysis oil, it is easily removed, and when used as an adsorbent or a neutralizing agent, regeneration and replacement cycles may be increased, and thus, it is preferred in terms of process simplification.

The particle size of the slag composition may refer to D50, i.e., to a diameter of a particle with a cumulative volume of 50% when cumulated from the smallest particle in measurement of a particle size distribution by a laser scattering method. Here, for measuring the D50, the particle size distribution may be measured by collecting a sample for the prepared carbonaceous material according to a KS A ISO 13320-1 standard, using Mastersizer 3000 from Malvern Panalytical Ltd. Specifically, a volume density may be measured after dispersion is performed using ethanol as a solvent, and, if necessary, using an ultrasonic disperser.

The BET specific surface area of the slag composition may be measured by a gas adsorption method (BET) which is commonly applied in the corresponding technical field, and Ar is adsorbed on a sample and the specific surface area of the sample surface may be analyzed, but the embodiments of the present disclosure are not limited thereto.

The compressive strength may be measured by manufacturing a commonly applied slag specimen and measuring a maximum stress until the specimen is broken by the compression, but the embodiments are not limited thereto.

The pyrolysis reactor may be a high temperature and high pressure reactor (autoclave reactor), a batch reactor (batch stirred reactor), a fluidized-bed reactor, a fixed bed reactor (packed-bed reactor), and the like, and specifically, may be all reactors allowing both stirring and heating control. For example, in an embodiment of the present disclosure the pyrolysis reactor may be a batch reactor.

The pyrolysis process may further include a pyrolysis gas recovery process of recovering a pyrolysis gas phase and a pyrolysis liquid phase as a gas, and a separation process of separating a pyrolysis solid phase (solid content) into fine particles and coarse particles.

In the gas recovery process, pyrolysis gas including low-boiling point hydrocarbon compounds such as methane (CH₄), ethane (C₂H₆), propane (C₃H₈), and the like is recovered from a gas phase produced in the pyrolysis process. The pyrolysis gas generally includes combustible materials such as hydrogen, carbon monoxide, and low-molecular weight hydrocarbon compounds. An example of the hydrocarbon compound includes methane, ethane, ethylene, propane, propene, butane, butene, and the like. Since the pyrolysis gas includes the combustible materials, it may be used as a fuel.

In the separation process, a solid content in a solid phase produced in the pyrolysis process, for example, a carbide, a neutralizing agent, and/or a copper compound may be separated into fine particles and coarse particles. Specifically, sorting is performed using a sieve which is larger than an average particle diameter of a chlorine-containing plastic and also is smaller than an average particle diameter of the neutralizing agent and the copper compound, thereby separating the solid content produced by a pyrolysis reaction into fine particles and coarse particles. In the separation process, it is preferred that the solid content is separated into fine particles which include more chlorine-containing neutralizing agent and copper compound, and coarse particles which include more carbide. The fine particles and the coarse particles may be retreated, if necessary and may be reused in the pyrolysis process, used as a fuel, or discarded, and the embodiments are not limited thereto.

The pyrolysis oil produced in the pyrolysis process may include less than 500 ppm, 300 ppm or less, 200 ppm or less, or 100 ppm or less of total chlorine and less than 200 ppm, 100 ppm or less, or 90 ppm or less of organic chlorine, with respect to the total weight.

In the method of producing a waste plastic pyrolysis oil according to an embodiment of the present disclosure, plastic pretreatment operation may be further a waste included before the pyrolysis process, and also, the pretreatment operation may further include putting waste plastics into a screw reactor and pulverizing them at room temperature.

A pulverizing process known in the art may be applied to the pulverization of the waste plastics, and for example, waste plastics may be put into a pretreatment reactor, which is heated to about 300° C. to produce a hydrocarbon flow precursor in a pellet form, but the embodiments are not limited thereto. As an example, the pulverization process may include mixing the waste plastics and a neutralizing agent and putting the mixture into the reactor. When the waste plastics, calcium oxide as the neutralizing agent, and the like are mixed and pulverized at room temperature, mechanochemical reaction may occur to produce hydrocarbon and CaOHCl, which has an effect of stably fixing chlorine in the waste plastic raw material to CaOHCl.

The pretreatment process is then characterized by putting the pulverized waste plastic into a pretreatment reactor and heating the reactor, and may be treating a solid waste plastic raw material physiochemically to remove a part of chlorine and produce a hydrocarbon flow precursor (raw material of a pyrolysis process). The hydrocarbon flow precursor may refer to a waste plastic melt, and the waste plastic melt may refer to all or a part of pulverized or finely pulverized solid waste plastics produced into liquid waste plastics (melt).

The heating may be performed at a temperature of 200 to 320° C. under normal pressure. Specifically, it is preferred to perform heating at 250 to 320° C. or 280 to 300° C. In general, the pretreatment temperature of waste plastics is at least 250° C., but the pretreatment in hydrocarbon after dechlorination may be easily performed even at a lower temperature of 200° C. to generate hydrogen or methane gas. Therefore, a flammable gas such as hydrogen or methane may be produced by the pretreatment process of the embodiments of the present disclosure without generation of harmful gases.

The pretreatment reactor may be an extruder, a high temperature and high pressure reactor (autoclave reactor), a batch reactor, and the like, and as an example, an auger reactor may be used, however, the embodiments are not limited thereto.

Hereinafter, specific examples and comparative examples of the embodiments of the present disclosure will be described. However, the following examples are only provided for illustrative purposes, and the embodiments are not limited thereto.

### EXAMPLES

### Example 1

4 tons of household vinyl wastes and 10 wt % of slag were put into a batch pyrolysis reactor, and were pyrolyzed to 500° C. The produced pyrolysis gas was passed through a gas separator and a cooler, and separated into a pyrolysis oil and water in an oil-water separator. The pyrolysis oil was passed through solid/liquid separation and liquid/liquid separation in a sedimentation tank, a centrifuge, and the like, and collected in a storage tank.

At this time, a steel-making slag having a particle size (D50) of 70 μm, a BET specific surface area of 4 m²/g, and the chemical composition of the following Table 1 was used as a slag composition.

The used household waste plastics were mixed household waste plastics such as PP, PE, PVC, and nylon. The total Cl content in the household waste plastic was 11000 ppm.

TABLE 1

| Composition (wt %) | SiO₂ | CaO | Al₂O₃ | T—Fe | MgO | SO₃ | Others |
|---|---|---|---|---|---|---|---|
| Blast furnace slag | 33.80 | 41.81 | 11.77 | 0.49 | 6.86 | 0.50 | 4.77 |
| Steel-making slag | 13.80 | 44.30 | 1.50 | 17.50 | 6.40 | — | 16.5 |

(In Table 1, T—Fe refers to total iron (iron oxide) including Fe₂O₃ and Fe₃O₄ occurring in the operation of a steel mill sinter plant as a main component.)

### Examples 2 to 4

A pyrolysis oil was produced in the same manner as in Example 1, except that a slag using a steel-making slag having different D50 and BET specific surface area was used. In Example 2, a steel-making slag composition having a particle size (D50) of 82 μm and a BET specific surface area of 4.8 m²/g was used, in Example 3, a steel-making slag composition having a particle size (D50) of 71 μm and a BET specific surface area of 3.7 m²/g was used, and in Example 4, a steel-making slag composition having a particle size (D50) of 93 μm and a BET specific surface area of 7.6 m²/g was used, and their chemical compositions are as shown in the following Table 2.

TABLE 2

| | SiO₂ | CaO | Al₂O₃ | T—Fe | MgO | SO₃ | Others |
|---|---|---|---|---|---|---|---|
| Example 2 | 13.8 | 49.6 | 2.8 | 13.2 | 2.7 | 13.8 | 17.9 |
| Example 3 | 12.7 | 43.1 | 2.9 | 18.9 | 5.7 | 12.7 | 16.7 |
| Example 4 | 10.4 | 45.8 | 2.4 | 19.6 | 5.2 | 10.4 | 16.6 |

In Table 2, T—Fe refers to total iron (iron oxide) including Fe₂O₃ and Fe₃O₄ occurring in the operation of a steel mill sinter plant as a main component.

### Evaluation Example 1: Interpretation of Results of Reduced Impurities in Pyrolysis Oil

### Comparative Example 1

A pyrolysis oil was recovered in the same manner as in Example 1, except that the slag composition was not used.

### Comparative Example 2

A pyrolysis oil was recovered in the same manner as in Example 1, except that CaO particles were used instead of the slag composition.

At this time, the CaO particles had a particle size (D50) of 48.3 μm and a BET specific surface area of 5.9 m²/g.

### Comparative Example 3

A pyrolysis oil was recovered in the same manner as in Example 1, except that a spent FCC catalyst was used instead of the slag composition.

At this time, the spent FCC catalyst had a particle size (D50) of 73.6 μm and a BET specific surface area of 151 m²/g.

### Comparative Example 4

A pyrolysis oil was recovered in the same manner as in Example 1, except that the blast furnace slag (see Table 1) was used instead of the steel-making slag.

### Evaluation Method

ICP, TNS, EA-O, and XRF analyses were performed for analyzing the impurity Cl in the waste plastic pyrolysis oils produced in Examples 1 to 3 and Comparative Examples 1 to 3. The results are summarized in the following Table 3.

TABLE 3

| | Example | Example | Example | Example | Comparative | Comparative | Comparative | Comparative |
|---|---|---|---|---|---|---|---|---|
| | 1 | 2 | 3 | 4 | Example 1 | Example 2 | Example 3 | Example 4 |
| Total Cl in | 11,000 | | | | | | | |
| feed (ppm) | | | | | | | | |
| Total Cl in | 98 | 97 | 55 | 27 | 736 | 152 | 391 | 114 |
| oil (ppm) | | | | | | | | |
| Organic Cl | 90 | 92 | 51 | 22 | 559 | 95 | 228 | 97 |
| in oil | | | | | | | | |
| (ppm) | | | | | | | | |

Referring to Table 3, in Example 1 using the slag composition as a pyrolysis additive, it was confirmed that Cl reduction performance was much better than that of the E-cat (spent FCC catalyst), and was at a higher level than that of commonly used CaO.

In addition, upon comparison of the results of Example 1 with Comparative Example 4, when the steel-making slag satisfying the chemical composition of the slag composition of the embodiments of the present disclosure was used among the steel slags, the Cl reduction effect was better than that using the blast furnace slag which did not satisfy the composition.

In addition, referring to the following Table 4 with Table 3, it was confirmed that when the chemical composition of the steel-making slag satisfied both Equations 1 and 2 as in Example 3, the chlorine reduction performance was significantly better than that of Example 1 or 2 satisfying one of Equations 1 and 2, and the chlorine reduction performance was the best when the chemical composition of the steel-making slag was the same as that of Example 4.

TABLE 4

| | | | | | | Comparative |
|---|---|---|---|---|---|---|
| | | Example 1 | Example 2 | Example 3 | Example 4 | Example 4 |
| Equation | Satisfied | ∘ | x | ∘ | ∘ | x |
| 1 | Value | 1.26 | 0.956 | 1.48 | 1.88 | 0.14 |
| Equation | Satisfied | x | ∘ | ∘ | ∘ | x |
| 2 | Value | 2.73 | 4.88 | 3.31 | 3.76 | 0.71 |

In Table 4, Equation 1 is 1<iron oxide (wt %)/silicon oxide (wt %)<3, and Equation 2 is 3<iron oxide (wt %)/magnesium oxide (wt %)<5.

Although the embodiments of the present disclosure have been described above, the present disclosure is not limited to the embodiments but may be made in various forms different from each other, and those skilled in the art will understand that the embodiments may be implemented in other specific forms without departing from the spirit or essential feature of the present disclosure. Therefore, it should be understood that the embodiments described above are not restrictive, but illustrative in all aspects. Furthermore, the embodiments may be combined to form additional embodiments.

1. A method of producing a waste plastic pyrolysis oil, the method comprising a pyrolysis process of putting waste plastics and a slag composition into a pyrolysis reactor to produce a pyrolysis oil,
wherein the slag composition includes 30 to 60 wt % of a calcium oxide; 5 to 30 wt % of an iron oxide; and 0.5 to 30 wt % of at least one selected from a silicon oxide, an aluminum oxide, and a magnesium oxide, with respect to a total weight.

2. The method of producing a waste plastic pyrolysis oil of claim 1, wherein the slag composition satisfies the following Equations 1 and 2:
$$1 < iron oxide ( wt \% ) / silicon oxide ( wt \% ) < 3 \qquad [ Equation 1 ]$$
$$3 < iron oxide ( wt \% ) / magnesium oxide ( wt \% ) < 5. \qquad [ Equation 2 ]$$

3. The method of producing a waste plastic pyrolysis oil of claim 1, wherein the slag composition includes 5 wt % or less of the aluminum oxide with respect to the total weight.

4. The method of producing a waste plastic pyrolysis oil of claim 1, wherein the slag composition includes 20 wt % or less of the silicon oxide with respect to the total weight.

5. The method of producing a waste plastic pyrolysis oil of claim 1, wherein the pyrolysis process is performed at a temperature of 400 to 600° C. under a non-oxidizing atmosphere.

6. The method of producing a waste plastic pyrolysis oil of claim 1, wherein the waste plastics are household waste plastics including 3 wt % or more of polyvinyl chloride (PVC) with respect to the total weight.

7. The method of producing a waste plastic pyrolysis oil of claim 1, wherein the slag composition has a BET specific surface area of 0.5 to 10 m²/g.

8. The method of producing a waste plastic pyrolysis oil of claim 1, wherein the slag composition has a particle size of 5 to 200 μm.

9. The method of producing a waste plastic pyrolysis oil of claim 1, wherein the slag composition has a compressive strength of 100 to 500 MPa.

10. The method of producing a waste plastic pyrolysis oil of claim 1, wherein the slag composition has a density of 1.5 to 5 g/cm².

11. The method of producing a waste plastic pyrolysis oil of claim 1, wherein the pyrolysis oil includes less than 100 ppm of chlorine with respect to the total weight.
